(19) United States
(12) Patent Application Publication
(10) Pub. No.: US 2025/0036358 A1
(43) Pub. Date: Jan. 30, 2025

(54) COMPUTER INSTRUCTIONS TO OPTIMIZE PROCESSING WITHIN A COMPUTING ENVIRONMENT

(71) Applicant: INTERNATIONAL BUSINESS MACHINES CORPORATION, Armonk, NY (US)

(72) Inventors: William Gerald O'FARRELL, Markham (CA); Christopher ANAND, Dundas (CA); James YOU, Toronto (CA); Lucas DUTTON, Hamilton (CA); Steven GONDER, Hamilton (CA); Felix FONG, Markham (CA); Silvia Melitta MUELLER, St. Ingbert (DE)

(21) Appl. No.: 18/358,586

(22) Filed: Jul. 25, 2023

(51) Int. Cl. G06F 5/01; G06F 7/50; G06F 7/523; G06F 7/76

(52) U.S. Cl. CPC G06F 5/01; G06F 7/50; G06F 7/523; G06F 7/76

(57) ABSTRACT

A multi-operation computer instruction is executed to obtain an intermediate result. The execution includes selecting digits of a plurality of digits of multiple values to be multiplied. A location defined to hold a digit is greater in size than the size of the digit and further defined to hold a carry digit. The digits are selected from a predefined group of digits of a plurality of predefined groups based on a selection control of the instruction. The digits selected are multiplied to obtain a plurality of results. At least one result may be shifted a preselected amount to obtain at least one shifted result. One or more results and any shifted results, at least, are added to obtain an intermediate result. Execution of the instruction is repeated for multiple other predefined groups providing a plurality of intermediate results used to obtain a product of multiplying the multiple values.

### BACKGROUND

One or more aspects relate, in general, to processing within a computing environment, and in particular, to facilitating such processing.

Often, computer applications, including, but not limited to, those that perform secure communications within a computing environment perform many and/or complex operations. These operations include computations that may require substantial computer resources and processing time to perform.

To perform the operations, including the computations, computer instructions are used. These instructions, however, often require duplication of calculations when the computation is to process higher and lower digits.

### SUMMARY

Shortcomings of the prior art are overcome, and additional advantages are provided through the provision of a computer program product for facilitating processing within a computing environment. The computer program product includes one or more computer readable storage media and program instructions collectively stored on the one or more computer readable storage media readable by at least one processing circuit to execute a multi-operation computer instruction to obtain an intermediate result. Execution of the multi-operation computer instruction includes selecting, by at least one computing device of the computing environment, digits of a plurality of digits to be multiplied. A location defined to hold a digit of the plurality of digits is greater in size than a size of the digit and is further defined to hold a carry digit. The plurality of digits is of multiple values to be multiplied to obtain a product, and the digits selected to be multiplied are selected from a predefined group of digits of a plurality of predefined groups of digits chosen based on a selection control of the multi-operation computer instruction. The digits selected to be multiplied are multiplied to obtain a plurality of results. At least one result is shifted a preselected amount to obtain at least one shifted result, based on determining based on the predefined group of digits that a shift is to be performed. At least one or more results of the plurality of results and the at least one shifted result, based on determining that the shift is to be performed, are added to obtain an intermediate result of a plurality of intermediate results. The execution of the multi-operation computer instruction is repeated multiple times for multiple other predefined groups of digits of the plurality of predefined groups of digits to obtain the plurality of intermediate results. The plurality of intermediate results is used to obtain the product.

Computer-implemented methods and systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to incorporate and use one or more aspects of the present disclosure;

FIG. 2 depicts one example of further details of a processor of the processor set of FIG. 1, in accordance with one or more aspects of the present disclosure;

FIG. 3A depicts one example of sub-modules of a multi-digit processing module of FIG. 1, in accordance with one or more aspects of the present disclosure;

FIG. 3B depicts one example of sub-modules of the execute multi-operation instruction sub-module of FIG. 3A, in accordance with one or more aspects of the present disclosure;

FIG. 3C depicts one example of sub-modules of the execute shift-add instruction sub-module of FIG. 3A, in accordance with one or more aspects of the present disclosure;

FIG. 4 depicts one example of multi-digit processing, in accordance with one or more aspects of the present disclosure;

FIG. 5A depicts one example of a format of a multi-operation instruction, in accordance with one or more aspects of the present disclosure;

FIG. 5B depicts one example of multi-operation instruction processing, in accordance with one or more aspects of the present disclosure;

FIG. 5C depicts one example of perform operation processing of the multi-operation instruction processing of FIG. 5B, in accordance with one or more aspects of the present disclosure;

FIG. 5D depicts one example of the perform operation processing based on a mask value of 00, in accordance with one or more aspects of the present disclosure;

FIG. 5E depicts one example of the perform operation processing based on a mask value of 01, in accordance with one or more aspects of the present disclosure;

FIG. 5F depicts one example of the perform operation processing based on a mask value of 10, in accordance with one or more aspects of the present disclosure;

FIG. 5G depicts one example of the perform operation processing based on a mask value of 11, in accordance with one or more aspects of the present disclosure;

FIG. 6 depicts one example of hardware for the perform operation processing of FIGS. 5D-5G, in accordance with one or more aspects of the present disclosure;

FIG. 7A depicts one example of a format of a shift-add instruction used in accordance with one or more aspects of the present disclosure;

FIG. 7B depicts one example of shift/add instruction processing, in accordance with one or more aspects of the present disclosure;

FIG. 7C depicts one example of perform shift/add operation processing of the shift/add instruction processing of FIG. 7B, in accordance with one or more aspects of the present disclosure;

FIG. 7D depicts one example of the perform shift/add processing based on a mask value of 00, in accordance with one or more aspects of the present disclosure;

FIG. 7E depicts one example of the perform shift/add processing based on a mask value of 01, in accordance with one or more aspects of the present disclosure;

FIG. 7F depicts one example of the perform shift/add processing based on a mask value of 10, in accordance with one or more aspects of the present disclosure;

FIG. 7G depicts one example of the perform shift/add processing based on a mask value of 11, in accordance with one or more aspects of the present disclosure;

FIG. 8 depicts one example of using a plurality of shift-add instructions to determine a result, in accordance with one or more aspects of the present disclosure;

FIG. 9A depicts one example of configuring digits to be processed, in accordance with one or more aspects of the present disclosure;

FIG. 9B depicts another example of configuring digits to be processed, in accordance with one or more aspects of the present disclosure;

FIGS. 10A-10D pictorially depict examples of the digits processed based on the mask values of FIGS. 5D-5G, in accordance with one or more aspects of the present disclosure; and

FIGS. 11A-11B depict another example of a computing environment to incorporate and use one or more aspects of the present disclosure.

### DETAILED DESCRIPTION

In accordance with one or more aspects of the present disclosure, a capability is provided to facilitate processing within a computing environment. In one or more aspects, the capability includes optimizing processing within the computing environment that performs computations on multiple digits (e.g., large digits). In one example, for selected computations (e.g., those with a long latency), each digit of the multiple digits is included (e.g., placed, stored, held, operated on, etc.) in a location (e.g., register; memory location of a defined size; etc.) that is of a predefined size; however, the predefined size is greater than a size of the digit, such that the predefined size includes space for a carry digit of a selected size (e.g., one or more bits). For instance, the digit may be 30 bits and included in a 32-bit register, in which the remaining two bits are used for a carry digit (e.g., of up to two bits), if there is a carry. Thus, in one or more aspects, the predefined size of the location to include a digit is to have a preselected amount of space for a carry digit. This enables selected computations that use carry digits to be performed absent use of a separate carry register or other separate memory location for the carry digit.

In one or more aspects, instructions are provided that facilitate computational processing involving multiple digits. In one or more aspects, the instructions include a multi-operation instruction (also referred to as a multi-operation computer instruction) and a shift-add instruction (also referred to as a shift-add computer instruction). In one or more aspects, the multi-operation instruction performs multiply and add operations on multi-digit inputs, selectable based on a selection control (e.g., a mask) provided by the instruction, and optionally, performs a shift operation selectable based on the selection control to provide an intermediate result, which may be shifted. The multi-operation instruction is executed a plurality of times, depending on the number of digits to be multiplied, to provide a plurality of intermediate results, one or more of which may be shifted intermediate results. The multi-operation instruction is an instruction that may have a long latency, and therefore, maintains a carry digit (e.g., one or more carry bits) as part of a digit being processed.

Further, in one or more aspects, the shift-add instruction uses the plurality of intermediate results to obtain a product of multiple (e.g., two) values, each value including a plurality of digits (e.g., four, eight, other number of digits, etc.).

In one or more aspects, processing used to multiply multiple values (e.g., two values) to obtain a product is facilitated, reducing hardware used to perform the multiply and reducing duplicative calculations. Each value of the multiple values includes multiple digits, and therefore, a plurality of digits is multiplied to obtain the product. To facilitate the multiplication, the plurality of digits is grouped into a plurality of predefined groups of digits and processing is performed on the predefined groups using the multi-operation instruction and the shift-add instruction.

For example, the multi-operation instruction is executed for each group of the predefined groups providing an intermediate result, which may be shifted. Based on executing the multi-operation instruction for each group of the plurality of predefined groups, a plurality of intermediate results is obtained, one or more of which may be shifted. The plurality of intermediate results (shifted or not) is then input to executions of the shift-add instruction to provide a product of the multiple values.

Processing of the multi-operation instruction is implemented, in one example, using a plurality of multiplexors used to select digits of the plurality of digits to be multiplied. The multiplexors select the digits based on a selection control, such as a mask value of the instruction, which is based, e.g., on the predefined groups. The number of multiplexors used is optimized based on the predefined groups of the plurality of digits.

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) that, e.g., performs multi-digit processing and/or one or more other aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), crasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

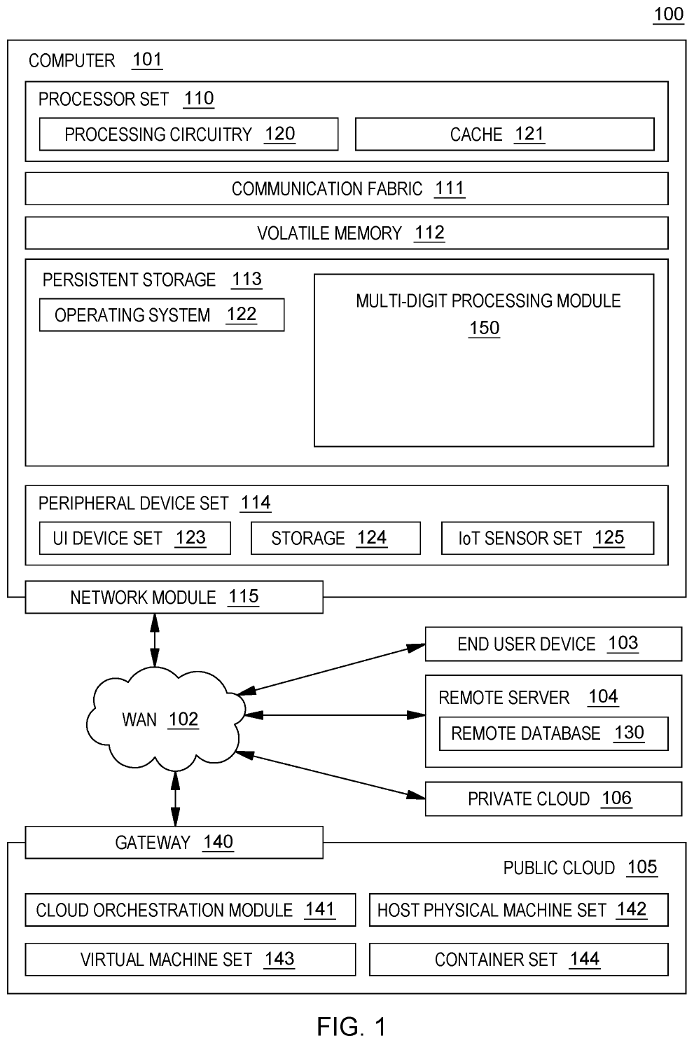

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as multi-digit processing code or module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present disclosure. Other examples are possible. For instance, in one or more embodiments, one or more of the components/modules of FIG. 1 are not included in the computing environment and/or are not used for one or more aspects of the present disclosure. Further, in one or more embodiments, additional and/or other components/modules may be used. Other variations are possible.

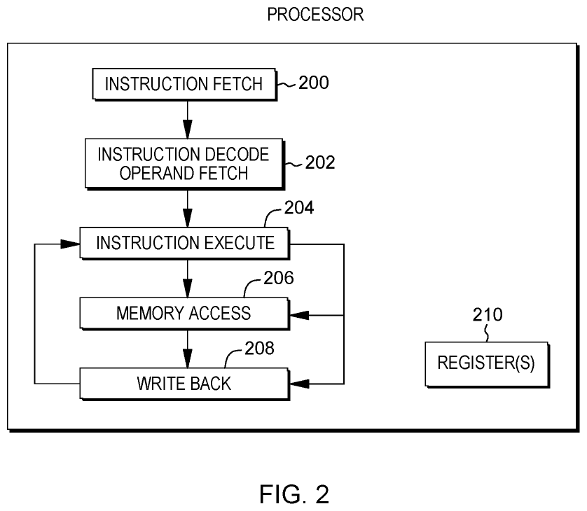

In one example, a processor (e.g., of processor set 110) includes a plurality of functional components (or a subset thereof) used to execute instructions. As depicted in FIG. 2, in one example, these functional components include, for instance, an instruction fetch component 200 to fetch instructions to be executed; an instruction decode/operand fetch component 202 to decode the fetched instructions and to obtain operands of the decoded instructions; one or more instruction execute components 204 to execute the decoded instructions; a memory access component 206 to access memory for instruction execution, if necessary; and a write back component 208 to provide the results of the executed instructions. One or more of the components may access and/or use one or more registers 210 in instruction processing. Further, one or more of the components may access and/or use multi-digit processing module 150. Additionally, fewer and/or other components may be used in one or more aspects of the present disclosure.

In one example, a multi-digit processing module (e.g., multi-digit processing module 150) is used, in accordance with one or more aspects of the present disclosure. A multi-digit processing module (e.g., multi-digit processing module 150) includes code or instructions used to perform multi-digit processing, in accordance with one or more aspects of the present disclosure. A multi-digit processing module (e.g., multi-digit processing module 150) includes, in one example, various sub-modules to be used to perform the processing. The sub-modules are, e.g., computer readable program code (e.g., instructions) in computer readable media, e.g., storage (storage 124, persistent storage 113, cache 121, other storage, as examples). The computer readable media may be part of one or more computer program products and the computer readable program code may be executed by and/or using one or more computing devices (e.g., one or more computers, such as computer(s) 101; one or more servers, such as remote server(s) 104; one or more devices, such as end user device(s) 103; one or more processors or nodes, such as processor(s) or node(s) of processor set 110; processing circuitry, such as processing circuitry 120 of processor set 110; and/or other computing devices, etc.). Additional and/or other computers, servers, devices, processors, nodes, processing circuitry and/or computing devices may be used to execute one or more of the sub-modules and/or portions thereof. Many examples are possible.

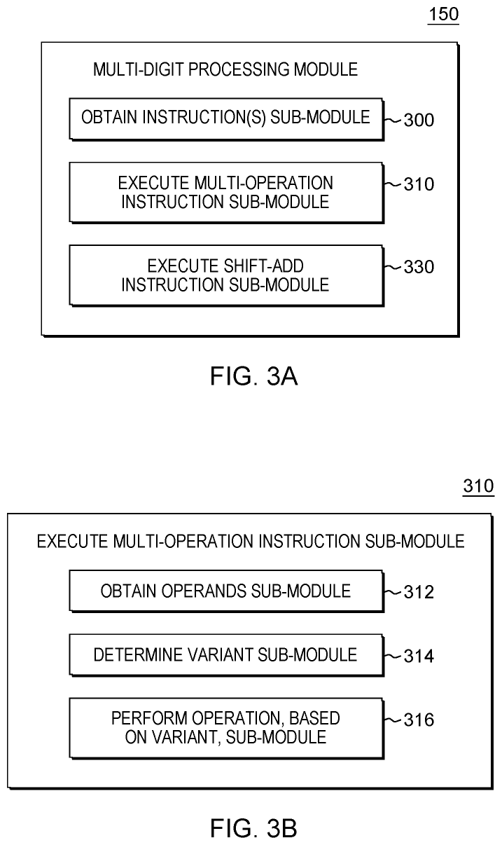

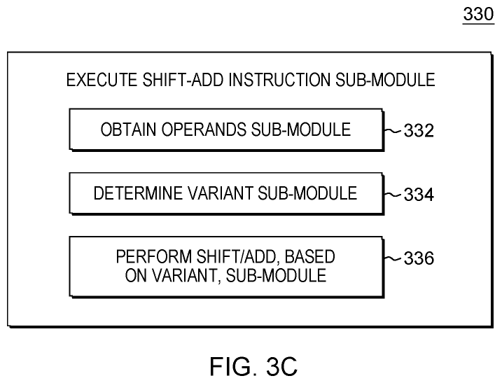

One example of multi-digit processing module 150 is described with reference to FIG. 3A. In one example, multi-digit processing module 150 includes an obtain instruction(s) sub-module 300 to obtain (e.g., receive, be provided, pull, retrieve, fetch, etc.) a multi-operation instruction and/or a shift-add instruction to be executed; an execute multi-operation instruction sub-module 310 to be used to execute the multi-operation instruction; and an execute shift-add instruction sub-module 330 to be used to execute the shift-add instruction. Multi-digit processing module 150 may include additional, fewer and/or other sub-modules. Many variations are possible.

In one example, referring to FIG. 3B, execute multi-operation instruction sub-module 310 includes, for instance, an obtain operands sub-module 312 to obtain one or more operands of the multi-operation instruction; a determine variant sub-module 314 to determine the instruction variant to be performed; and a perform operation, based on variant, sub-module 316 to perform the operation based on the determined variant. Sub-module 310 may include additional, fewer and/or other sub-modules. Many variations are possible.

In one example, referring to FIG. 3C, execute shift-add instruction sub-module 330 includes, for instance, an obtain operands sub-module 332 to obtain one or more operands of the shift-add instruction; a determine variant sub-module 334 to determine the shift-add instruction variant to be performed; and a perform shift/add, based on variant, sub-module 336 to perform the shift/add operation based on the determined variant. Sub-module 330 may include additional, fewer and/or other sub-modules. Many variations are possible.

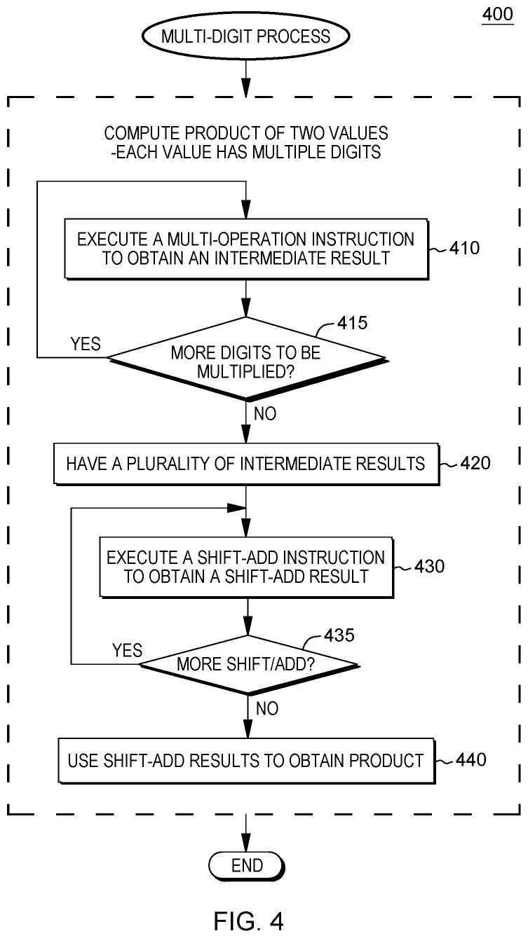

The multi-digit processing module (e.g., multi-digit processing module 150) is used, in one or more aspects, in multi-digit processing, as further described with reference to FIG. 4. In one example, a multi-digit process is executed by one or more computing devices (e.g., one or more computers (e.g., computer(s) 101, other computer(s), etc.), one or more servers (e.g., server(s) 104, other server(s), etc.), one or more devices (e.g., end-user device(s) 103, other device(s), etc.), one or more processors, nodes and/or processing circuitry, etc. (e.g., of processor set 110 or other processor sets), and/or one or more other computing devices, etc.). Although example computers, servers, devices, processors, nodes, processing circuitry and/or computing devices are provided, additional, fewer and/or other computers, servers, devices, processors, nodes, processing circuitry, and/or other computing devices may be used for the multi-digit processing and/or other processing. Various options are possible.

Referring to FIG. 4, in one example, a multi-digit process (e.g., multi-digit process 400) is used to compute a product of multiple (e.g., two) values, in which each value has multiple (e.g., four, eight, other number of) digits, such that a plurality of digits is multiplied to produce the product. In one or more aspects, multi-digit process 400 (also referred to as process 400) executes 410 a multi-operation instruction on selected digits of the plurality of digits to obtain an intermediate result. The digits are selected based on predefined groups of the plurality of digits, and a group of the predefined groups is selected in execution of the multi-operation instruction based on a selection control, such as a value of a mask of the instruction. The predefined groups are created to reduce the hardware to be used to implement the instruction and to reduce redundancy (e.g., duplicative calculations), thereby reducing costs and increasing processing speed within the computing device/computing environment.

Process 400 determines 415 whether there are more digits to be multiplied. If there are further digits to be multiplied (e.g., one or more additional groups of digits to be processed), processing continues to re-execute the multi-operation instruction for the next group of digits. If, however, there are no further digits to be multiplied, then multiple executions of the multi-operation instruction produce 420 a plurality of intermediate results (one or more of which may have been shifted, as described herein).

Further, in one or more aspects, process 400 executes 430 a shift-add instruction to perform a shift/add operation on one or more of the intermediate results to obtain a shift-add result. In one example, the one or more intermediate results to be processed (e.g., shifted and/or added) are selected based on a shift selection control, such as a mask value provided by the shift-add instruction. Process 400 determines 435 if further shift/add operations are to be performed. If there is one or more shift/add operations to be performed, process 400 executes 430 the shift-add instruction again on one or more other intermediate results to obtain shift-add results. If, however, the shift/add is complete, then process 400 uses 440 the shift-add results to obtain a product of the multiple values.

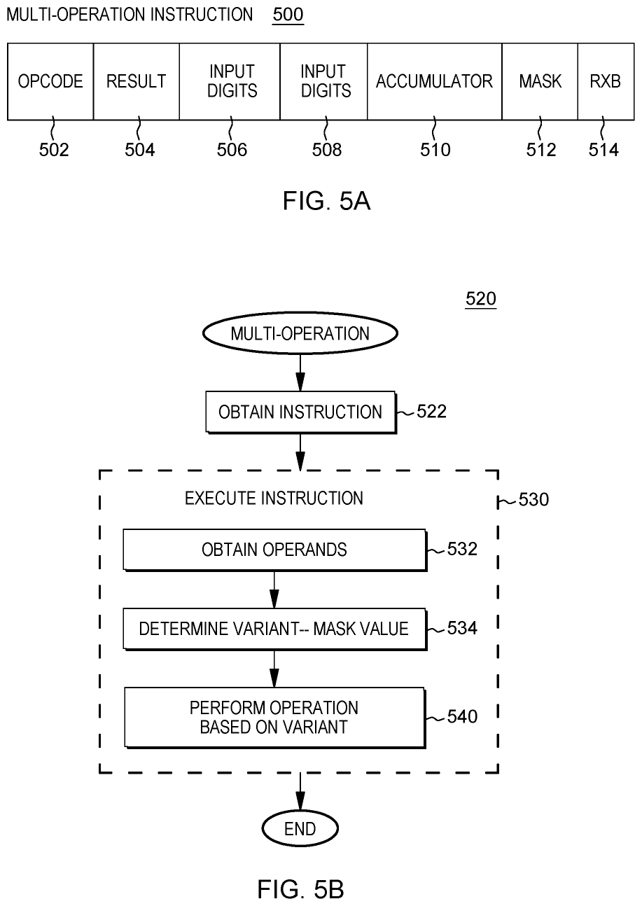

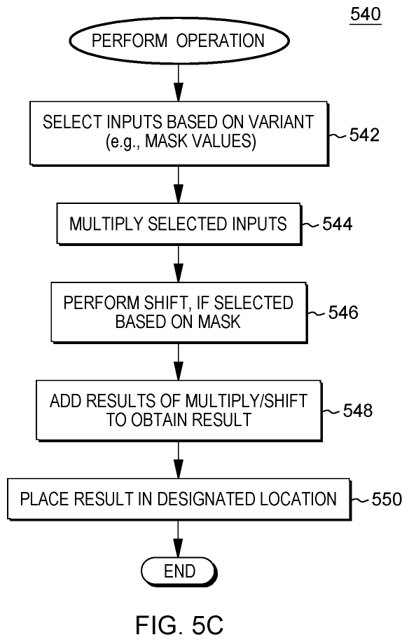

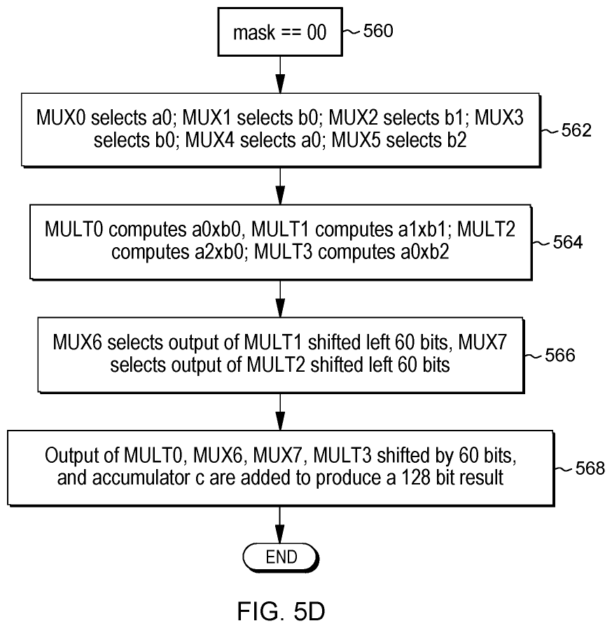

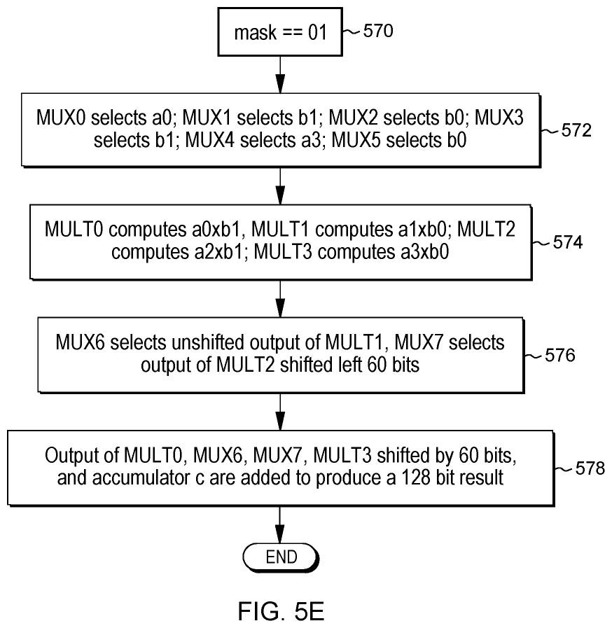

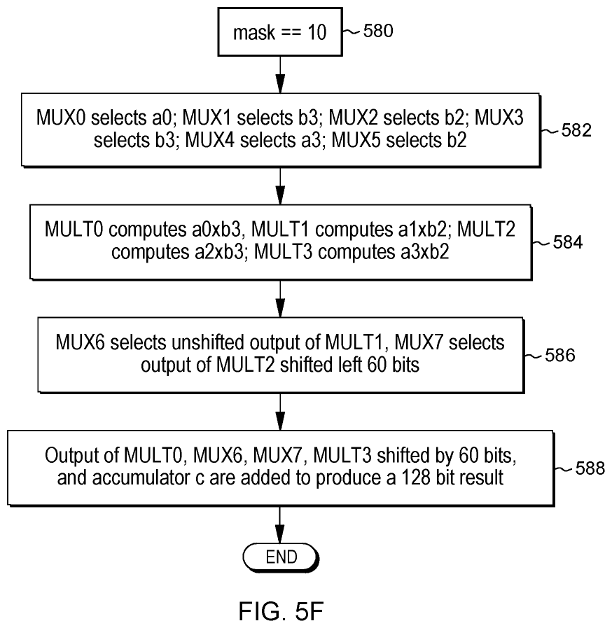

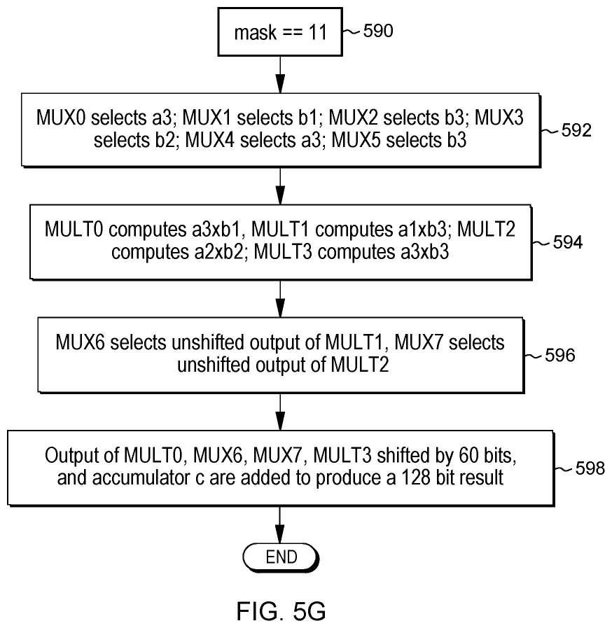

Further details relating to a multi-operation instruction are described with reference to FIG. 5A. In one embodiment, a multi-operation instruction, such as a multi-operation instruction 500, is a single architected hardware machine instruction at the hardware/software interface. As an example, it is part of an instruction set architecture. One example of an instruction set architecture to incorporate and/or use a multi-operation instruction and/or aspects of the present disclosure is the z/Architecture® instruction set architecture offered by International Business Machines Corporation, Armonk, New York. One embodiment of the z/Architecture instruction set architecture is described in a publication entitled, “z/Architecture Principles of Operation,” IBM Publication No. SA22-7832-13, Fourteenth Edition, May 2022, which is hereby incorporated herein by reference in its entirety. The z/Architecture instruction set architecture, however, is only one example architecture; other architectures and/or other types of computing environments of International Business Machines Corporation and/or of other entities/companies may include and/or use one or more aspects of the present disclosure. z/Architecture and IBM are trademarks or registered trademarks of International Business Machines Corporation in at least one jurisdiction.

Although the multi-operation instruction is referred to herein as the multi-operation instruction, it may be referred to by other names, and its name may depend on the instruction set architecture in which it is included. Many possibilities exist.

In one example, the multi-operation instruction is part of a vector facility of an instruction set architecture. The vector facility provides, for instance, fixed sized vectors ranging from, e.g., one to sixteen elements. Each vector includes data which is operated on by vector instructions defined in the facility. In one embodiment, if a vector is made up of multiple elements, then each element is processed in parallel with the other elements. Instruction completion does not occur, in one example, until processing of all the elements is complete. In other embodiments, the elements are processed partially in parallel and/or sequentially; and/or there may be additional elements.

In one embodiment, the vector facility uses a plurality of vector registers. For instance, a register file, which is an array of processor registers in a central processing unit (e.g., a processor of processor set 110), may include, e.g., 32 vector registers and each register is, e.g., 128 bits in length.

Vector data appears in storage in the same left-to-right sequence, for instance, as other data formats. Bits of a data format that are numbered 0-7 constitute the byte in the leftmost (lowest-numbered) byte location in storage, bits 8-15 form the byte in the next sequential location, and so on. In a further example, the vector data may appear in storage in another sequence, such as right-to-left.

Continuing with FIG. 5A, multi-operation instruction 500 includes a plurality of fields, including one or more operation code (opcode) fields 502 that indicate that this is a multi-operation. Although in FIG. 5A there is one opcode field 502 depicted, in other examples, there may be multiple opcode fields. For instance, there may be one opcode field at the beginning of the instruction format and another at the end of the instruction format. Other examples are also possible.

Further, in one example, multi-operation instruction 500 includes a result field 504 used to designate a result location (e.g., one or more vector registers) to store the intermediate result of execution of the multi-operation instruction; an input digits field 506 used to designate a location (e.g., one or more vector registers) to obtain digits to be input to the instruction; another input digits field 508 used to designate a location (e.g., one or more vector registers) to obtain other digits to be input to the instruction; an accumulator field 510 used to designate a location (e.g., one or more vector registers) to be optionally used to accumulate bits based on the operations being performed by the instruction; a mask field 512 used to indicate a particular variant of the instruction to be executed and to dynamically select inputs for the multiple operations to be performed by the multi-operation instruction; and optionally, in one embodiment, a register extension bit (RXB) field 514 to be used, in one example, with any field designating vector register(s) used by the instruction, as described below. In one embodiment, the fields of the instruction are separate and independent from one another; however, in other embodiments, more than one field may be combined. Further, although example types of registers are specified for the various fields, other types of registers may be used. For instance, the result field may specify one or more vector registers or other types of registers. Similarly, the input digits fields and/or the accumulator field, in other embodiments, may specify other than vector registers. Other examples are possible.

In one example, one or more of fields 504-510 may include an indication of one or more vector registers (e.g., V1, V2, V3, V4) to store the result, inputs and/or accumulator, and in one example, register extension bit (RXB) field 514 includes the most significant bit for a vector register designated operand. Bits for register designations not specified by the instruction are to be reserved and set to zero. The most significant bit is concatenated, for instance, to the left of a four-bit register designation of the vector register field (e.g., V1) to create a five-bit vector register designation.

In one example, the RXB field includes four bits (e.g., bits 0-3), and the bits are defined, as follows:
0—Most significant bit for V1.
1—Most significant bit for V2.
2—Most significant bit for V3.
3—Most significant bit for V4.

Each bit is set to zero or one by, for instance, the assembler depending on the register number. For instance, for registers 0-15, the bit is set to 0; for registers 16-31, the bit is set to 1, etc. Thus, a register containing the operand is specified using, for instance, a four-bit field of the register field with the addition of its corresponding register extension bit (RXB) as the most significant bit. For instance, if the four-bit field is 0110 and the extension bit is 0, then the five bit field 00110 indicates register number 6. In a further embodiment, the RXB field includes additional bits, and more than one bit is used as an extension for each vector or location. Further, in other embodiments, the assignment of RXB bits to operands and/or bits of the instruction format may be different than the example herein. Further, in other embodiments, the RXB field is not used. Other variations are possible.

In the description herein of a multi-operation instruction, such as multi-operation instruction 500, specific locations, specific fields and/or specific sizes of the fields may be indicated (e.g., specific bytes and/or bits). However, other locations, fields and/or sizes may be provided. Further, although the setting of a bit to a particular value, e.g., one or zero, may be specified, this is only an example. The bit, if set, may be set to a different value, such as the opposite value or to another value, in other examples. Many variations are possible.

A multi-operation instruction, such as multi-operation instruction 500, may have additional, fewer and/or other fields. For instance, one or more fields of a multi-operation instruction, such as multi-operation instruction 500, may be optional. As examples, one or more of accumulator field 510, mask field 512 and/or RXB field 514 are optional. For instance, a multi-operation instruction, such as multi-operation instruction 500, may not have an accumulator field, since one or more operations may not require such a field. In one or more examples, the specific variant is not specified using a mask field, instead, the instruction is configured to perform just one specific variant. In one or more examples, the variant may be specified by the opcode. In a further example, the RXB field is not used, instead, a register field includes an indication of the vector register. Many variations are possible.

In accordance with one or more aspects of the present disclosure, multi-operation processing, including execution of a multi-operation instruction, such as multi-operation instruction 500, is facilitated using a multi-digit processing module (e.g., multi-digit processing module 150) and/or a multi-operation instruction sub-module (e.g., execute multi-operation instruction sub-module 310). Multi-digit processing module 150 includes one or more sub-modules (e.g., sub-modules 300, 310) and execute multi-operation instruction sub-module 310 includes one or more sub-modules (e.g., sub-modules 312-316) that are used in multi-operation processing, as further described with reference to FIGS. 5B-5G. In one example, a multi-operation process is executed by one or more computing devices (e.g., one or more computers (e.g., computer(s) 101, other computer(s), etc.), one or more servers (e.g., server(s) 104, other server(s), etc.), one or more devices (e.g., end-user device(s) 103, other device(s), etc.), one or more processors, nodes and/or processing circuitry, etc. (e.g., of processor set 110 or other processor sets), and/or one or more other computing devices, etc.). Although example computers, servers, devices, processors, nodes, processing circuitry and/or computing devices are provided, additional, fewer and/or other computers, servers, devices, processors, nodes, processing circuitry, and/or other computing devices may be used for the multi-operation process and/or other processing. Various options are possible.

Referring to FIG. 5B, in one example, a multi-operation process 520 (also referred to as process 520) obtains 522 (e.g., receives, retrieves, fetches, is provided, pulls, etc.) an instruction, such as multi-operation instruction 500, and executes 530 the instruction. Execution includes, for instance, obtaining 532 one or more operands of the instruction. As examples, process 520 obtains one or more of: an operation code from opcode field 502, an indication of a result location (e.g., a vector register, etc.) from result field 504, input digits from input digits fields 506 and 508, a mask value from mask field 512 and a register extension bit from register extension bit field 514. The operands to be obtained depend, for instance, on which operands are specified using the instruction and/or are being used. As noted herein, some operands are optional and may not be used in various embodiments. Further, in one or more embodiments, additional, fewer and/or other operands may be used. Many variations are possible.

Based on obtaining the operands, in one example, process 520 determines 534 a variant of the instruction to be executed. For instance, a value of the mask field (e.g., mask field 512) is used to determine the variant. As an example, the mask includes two bits, and therefore, there are up to 4 variants, in this example. However, the mask may be of different sizes, and therefore, a different number of variants may be supported. Based on the value of the mask, and therefore, the variant, the input digits to be processed (e.g., multiplied) are dynamically selected, as well as an indication of whether shifting is to be performed, as described herein.

In one example, based on determining the mask value, process 520 performs 540 the operation based on the variant, e.g., the mask value. Further details relating to performing the operation are described with reference to FIGS. 5C-5G. For example, FIG. 5C depicts one example of an overview of performing the operation; and FIGS. 5D-5G depict examples of performing the operation based on selected mask values. In one example, the perform operation is executed by one or more computing devices (e.g., one or more computers (e.g., computer(s) 101, other computer(s), etc.), one or more servers (e.g., server(s) 104, other server(s), etc.), one or more devices (e.g., end-user device(s) 103, other device(s), etc.), one or more processors, nodes and/or processing circuitry, etc. (e.g., of processor set 110 or other processor sets), and/or one or more other computing devices, etc.). Although example computers, servers, devices, processors, nodes, processing circuitry and/or computing devices are provided, additional, fewer and/or other computers, servers, devices, processors, nodes, processing circuitry, and/or other computing devices may be used for the multi-operation process and/or other processing. Various options are possible.

In one example, referring to FIG. 5C, to perform the operation, process 540 selects 542 input digits of a plurality of input digits based on a value of a selection control, such as a mask of the instruction (e.g., mask field 512). In one example, each input digit is provided in, e.g., a vector register that includes the digit value as well as space for a carry digit (e.g., two bits), in case a carry is used during the processing (e.g., multiplication). Process 540 multiplies 544 the selected inputs providing results. Process 540 may perform a shift 546 of one or more results depending on the mask value, as further described below, potentially providing one or more shifted results.

Process 540 adds 548 the results and/or the shifted results to provide a result, referred to herein as an intermediate result. Process 540 places 550 the result in a designated location, such as a vector register specified by the instruction (e.g., result field 504).

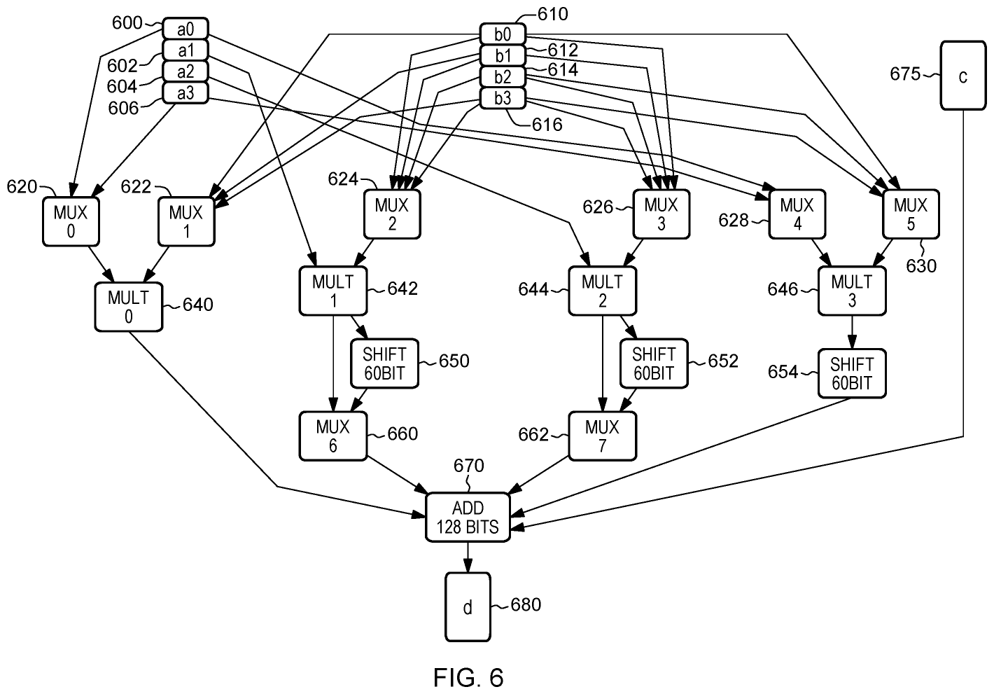

In one example, one or more aspects of the process are implemented in hardware using one or more multiplexors, one or more multipliers, one or more shifters, and at least one adder, as further described with reference to FIGS. 5D-5G and FIG. 6.

Referring to FIGS. 5D and 6, in one example, based on the mask value of the multi-operation instruction 500 being set to, e.g., 00, an operation variant 560 is performed. For instance, a multiplexor (e.g., mux0 620) selects 562 a digit (e.g., a0 600); a multiplexor (e.g., mux1 622) selects a digit (e.g., b0 610); a multiplexor (e.g., mux2 624) selects a digit (e.g., b1 612); a multiplexor (e.g., mux3 626) selects a digit (e.g., b0 610); a multiplexor (e.g., mux4 628) selects a digit (e.g., a0 600); and a multiplexor (e.g., mux5 630) selects a digit (e.g., b2 614).

Based on the multiplexors selecting the appropriate digits, those digits are multiplied 564. For instance, a multiplier (e.g., mult0 640) computes a0 x b0 providing a result (e.g., result 1); a multiplier (e.g., mult1 642) computes a1 x b1 providing a result (e.g., result 2); a multiplier (e.g., mult2 644) computes a2 x b0 providing a result (e.g., result 3); and a multiplier (e.g., mult3 646) computes a0 x b2 providing a result (e.g., result 4).

Further, based on the mask value, one or more of the results are shifted 566. As examples, for operation variant 560, a multiplexor (e.g., mux6 660) selects output of mult 1 642 shifted 650 in a selected direction (e.g., left) by a selected value (e.g., 60 bits) providing a shifted result (e.g., shifted result 1); and a multiplexor (e.g., mux7 662) selects output of mult2 644 shifted 652 in a selected direction (e.g., left) by a selected value (e.g., 60 bits) providing a shifted result (e.g., shifted result 2).

In one example, the results and shifted results are added together 568. For example, an adder (e.g., adder 670) adds the output of mult0 640 (e.g., result 1), mux6 660 (e.g., shifted result 1), mux7 662 (e.g., shifted result 2), mult3 646 (e.g., result 4) shifted 654 by a selected value (e.g., 60 bits) and the value in an accumulator 675, if present, to provide a result, which is stored at a location 680 specified by the instruction, such as a vector register. This result is referred to herein as an intermediate result, since it will be used to obtain the product of the two values represented by the digits (e.g., one value represented by digits a0-a3 and another value represented by digits b0-b3). It is one intermediate result of a plurality of intermediate results used to obtain the product.

In one example, accumulator 675 is used if, e.g., a value being multiplied to obtain the product has more than four digits. The accumulator is used to chain together the result from a previous execution of the same variant of the instruction.

Another operation variation is described with reference to FIGS. 5E and 6. In one example, based on the mask value being set to, e.g., 01, an operation variant 570 is performed. For instance, a multiplexor (e.g., mux0 620) selects 572 a digit (e.g., a0 600); a multiplexor (e.g., mux 1 622) selects a digit (e.g., b1 612); a multiplexor (e.g., mux2 624) selects a digit (e.g., b0 610); a multiplexor (e.g., mux3 626) selects a digit (e.g., b1 612); a multiplexor (e.g., mux4 628) selects a digit (e.g., a3 606); and a multiplexor (e.g., mux5 630) selects a digit (e.g., b0 610).

Based on the multiplexors selecting the appropriate digits, those digits are multiplied 574. For instance, a multiplier (e.g., mult0 640) computes a0 x b1 providing a result (e.g., result 1); a multiplier (e.g., mult1 642) computes a1 x b0 providing a result (e.g., result 2); a multiplier (e.g., mult2 644) computes a2 x b1 providing a result (e.g., result 3); and a multiplier (e.g., mult3 646) computes a3 x b0 providing a result (e.g., result 4).

Further, based on the mask value, one or more of the results are shifted 576. As examples, for operation variant 570, a multiplexor (e.g., mux6 660) selects output of mult1 642 not shifted maintaining the result (e.g., result 2); and a multiplexor (e.g., mux7 662) selects output of mult2 644 shifted 652 in a selected direction (e.g., left) by a selected value (e.g., 60 bits) providing a shifted result (e.g., shifted result 1).

In one example, the results and shifted result are added together 578. For example, an adder (e.g., adder 670) adds the output of mult0 640 (e.g., result 1), mux6 660 (e.g., result 2), mux7 662 (e.g., shifted result 1), mult3 646 (e.g., result 4) shifted 654 in a selected direction (e.g., left) by a selected value (e.g., 60 bits) and the value in an accumulator 675, if present, to provide a result (another immediate result), which is stored at a location 680 specified by the instruction, such as a vector register.

Another operation variation is described with reference to FIGS. 5F and 6. In one example, based on the mask value being set to, e.g., 10, an operation variant 580 is performed. For instance, a multiplexor (e.g., mux0 620) selects 582 a digit (e.g., a0 600); a multiplexor (e.g., mux1 622) selects a digit (e.g., b3 616); a multiplexor (e.g., mux2 624) selects a digit (e.g., b2 614); a multiplexor (e.g., mux3 626) selects a digit (e.g., b3 616); a multiplexor (e.g., mux4 628) selects a digit (e.g., a3 606); and a multiplexor (e.g., mux5 630) selects a digit (e.g., b2 614).

Based on the multiplexors selecting the appropriate digits, those digits are multiplied 584. For instance, a multiplier (e.g., mult0 640) computes a0 x b3 providing a result (e.g., result 1); a multiplier (e.g., mult1 642) computes a1 x b2 providing a result (e.g., result 2); a multiplier (e.g., mult2 644) computes a2 x b3 providing a result (e.g., result 3); and a multiplier (e.g., mult3 646) computes a3 x b2 providing a result (e.g., result 4).

Further, based on the mask value, one or more of the results are shifted 586. As examples, for operation variant 580, a multiplexor (e.g., mux6 660) selects output of mult1 642 not shifted maintaining the result (e.g., result 2); and a multiplexor (e.g., mux7 662) selects output of mult2 644 shifted 652 in a selected direction (e.g., left) by a selected value (e.g., 60 bits) providing a shifted result (e.g., shifted result 1).

In one example, the results and shifted result are added together 588. For example, an adder (e.g., adder 670) adds the output of mult0 640 (e.g., result 1), mux6 660 (e.g., result 2), mux7 662 (e.g., shifted result 1), mult3 646 (e.g., result 4) shifted 654 in a selected direction (e.g., left) by a selected value (e.g., 60 bits) and the value in an accumulator 675, if present, to provide a result (another intermediate result), which is stored at a location 680 specified by the instruction, such as a vector register.

Another operation variation is described with reference to FIGS. 5G and 6. In one example, based on the mask value being set to, e.g., 11, an operation variant 590 is performed. For instance, a multiplexor (e.g., mux0 620) selects 592 a digit (e.g., a3 606); a multiplexor (e.g., mux 1 622) selects a digit (e.g., b1 612); a multiplexor (e.g., mux2 624) selects a digit (e.g., b3 616); a multiplexor (e.g., mux3 626) selects a digit (e.g., b2 614); a multiplexor (e.g., mux4 628) selects a digit (e.g., a3 606); and a multiplexor (e.g., mux5 630) selects a digit (e.g., b3 616).

Based on the multiplexors selecting the appropriate digits, those digits are multiplied 594. For instance, a multiplier (e.g., mult0 640) computes a3 x b1 providing a result (e.g., result 1); a multiplier (e.g., mult1 642) computes a1 x b3 providing a result (e.g., result 2); a multiplier (e.g., mult2 644) computes a2 x b2 providing a result (e.g., result 3); and a multiplier (e.g., mult3 646) computes a3 x b3 providing a result (e.g., result 4).

Further, based on the mask value, in this example, none of the results are shifted 596. Thus, in one example, for operation variant 590, a multiplexor (e.g., mux6 660) selects output of mult1 642 (e.g., result 2); and a multiplexor (e.g., mux7 662) selects output of mult2 644 (e.g., result 3).

In one example, the results are added together 598. For example, an adder (e.g., adder 670) adds the output of mult0 640 (e.g., result 1), mux6 660 (e.g., result 2), mux7 662 (e.g., result 3), mult3 646 (e.g., result 4) shifted 654 in a selected direction (e.g., left) by a selected value (e.g., 60 bits) and the value in an accumulator 675, if present, to provide a result (another intermediate result), which is stored at a location 680 specified by the instruction, such as a vector register. In one example, with each variant, location 680 (e.g., vector register) includes space for the carry digit (e.g., two bits), which is used if needed.

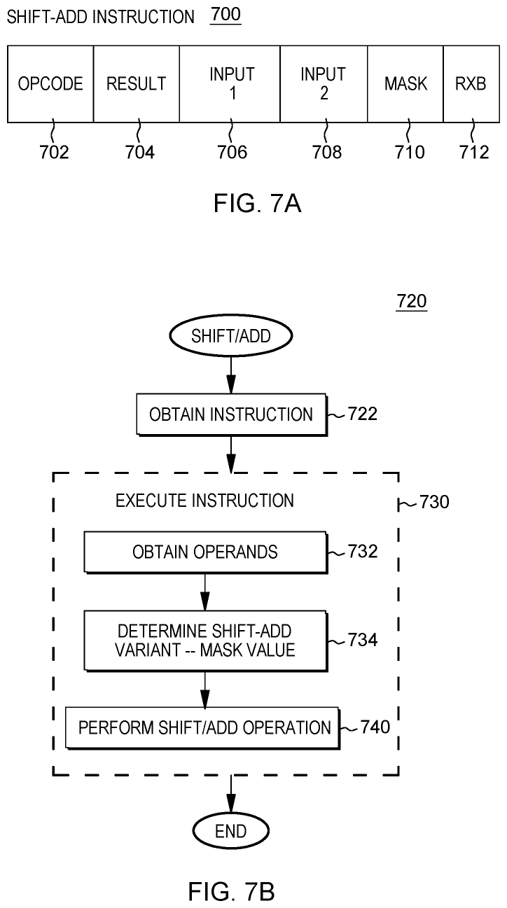

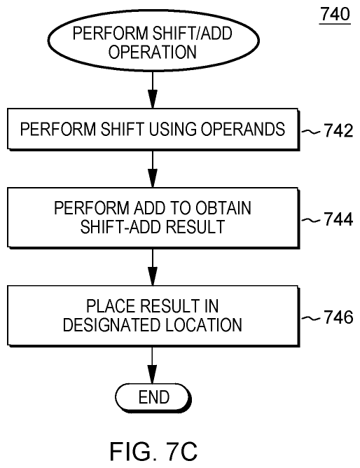

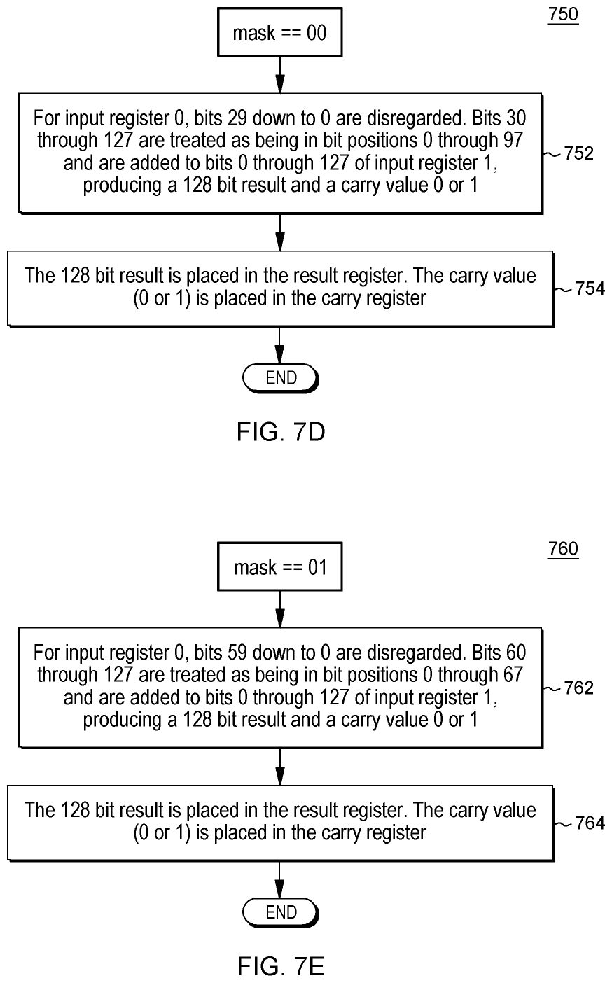

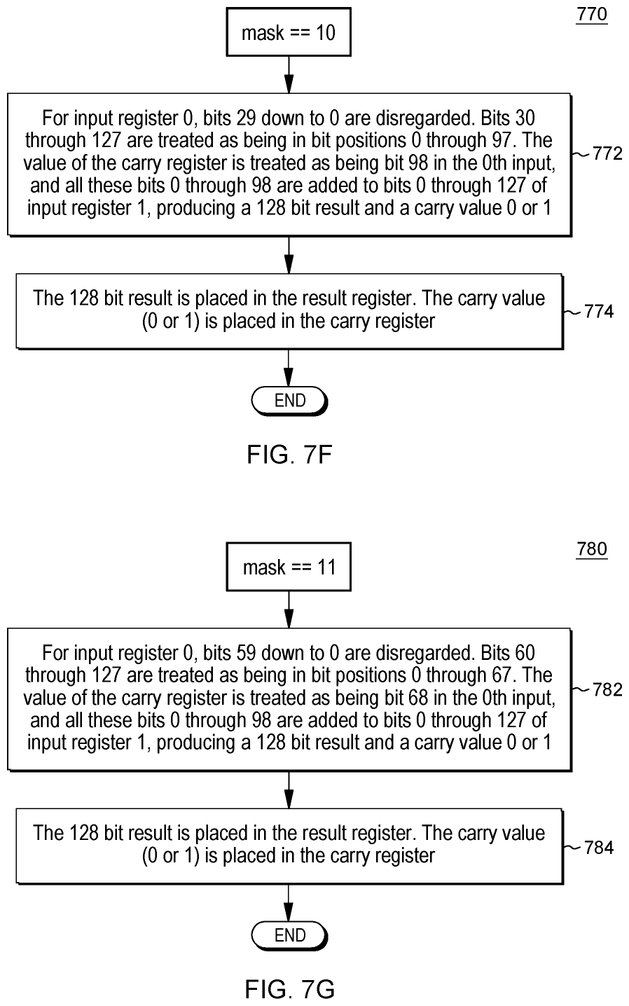

In accordance with one or more aspects, the plurality of intermediate results is used to obtain the product of multiple (e.g., two) values being multiplied. This includes, for instance, performing a shift/add of one or more of the intermediate results to provide shift-add results, which are used to generate the product of the multiple values. In one example, a shift-add instruction is used to perform the shift/add, an example of which is described with reference to FIG. 7A.

In one embodiment, a shift-add instruction, such as a shift-add instruction 700, is a single architected hardware machine instruction at the hardware/software interface. As an example, it is part of an instruction set architecture. One example of an instruction set architecture to incorporate and/or use a shift-add instruction and/or aspects of the present disclosure is the z/Architecture® instruction set architecture offered by International Business Machines Corporation, Armonk, New York. The z/Architecture instruction set architecture, however, is only one example architecture; other architectures and/or other types of computing environments of International Business Machines Corporation and/or of other entities/companies may include and/or use one or more aspects of the present disclosure.

Although the shift-add instruction is referred to herein as the shift-add instruction, it may be referred to by other names, and its name may depend on the instruction set architecture in which it is included. Many possibilities exist.

In one example, the shift-add instruction is part of a vector facility of an instruction set architecture, and includes a plurality of fields, including one or more operation code (opcode) fields 702 that indicate that this is a shift-add operation. Although in FIG. 7A there is one opcode field 702 depicted, in other examples, there may be multiple opcode fields. For instance, there may be one opcode field at the beginning of the instruction format and another at the end of the instruction format. Other examples are also possible.

Further, in one example, shift-add instruction 700 includes a result field 704 used to designate a result location (e.g., one or more vector registers) to store a shifted/added result of execution of the shift-add instruction; an input 1 field 706 used to designate a location (e.g., one or more vector registers) to obtain an input to the instruction; an input 2 field 708 used to designate a location (e.g., one or more vector registers) to obtain another input to the instruction; a mask field 710 used to indicate a particular variant of the shift-add instruction and to dynamically select inputs for the shift/add operation; and optionally, in one embodiment, a register extension bit (RXB) field 712 to be used, in one example, with any field designating vector register(s) used by the instruction, as described herein. In one embodiment, the fields of the instruction are separate and independent from one another; however, in other embodiments, more than one field may be combined. Further, although example types of registers are specified for the result field and the input fields, other types of registers may be used. For instance, the result field may specify one or more vector registers or other types of registers. Similarly, the input fields, in other embodiments, may specify other than vector registers. Other examples are possible.

In the description herein of a shift-add instruction, such as shift-add instruction 700, specific locations, specific fields and/or specific sizes of the fields may be indicated (e.g., specific bytes and/or bits). However, other locations, fields and/or sizes may be provided. Further, although the setting of a bit to a particular value, e.g., one or zero, may be specified, this is only an example. The bit, if set, may be set to a different value, such as the opposite value or to another value, in other examples. Many variations are possible.

A shift-add instruction, such as shift-add instruction 700, may have additional, fewer and/or other fields. For instance, one or more fields of a shift-add instruction, such as shift-add instruction 700, may be optional. As examples, one or more of mask field 710 and/or RXB field 712 are optional. For instance, a shift-add instruction, such as shift-add instruction 700, may not have a mask field, instead, the instruction is configured to perform just one specific shift/add variant. In one or more examples, the operation may be specified by the opcode. In a further example, the RXB field is not used, instead, various register fields include an indication of the vector register. Many variations are possible.

In accordance with one or more aspects of the present disclosure, shift/add processing, including execution of a shift-add instruction, such as shift-add instruction 700, is facilitated using a multi-digit processing module (e.g., multi-digit processing module 150) and/or a shift-add instruction sub-module (e.g., execute shift-add instruction sub-module 330). Multi-digit processing module 150 includes one or more sub-modules (e.g., sub-modules 300, 330) and execute shift-add instruction sub-module 330 includes one or more sub-modules (e.g., sub-modules 332-336) that are used in shift/add processing, as further described with reference to FIGS. 7B-7G. In one example, a shift/add process is executed by one or more computing devices (e.g., one or more computers (e.g., computer(s) 101, other computer(s), etc.), one or more servers (e.g., server(s) 104, other server(s), etc.), one or more devices (e.g., end-user device(s) 103, other device(s), etc.), one or more processors, nodes and/or processing circuitry, etc. (e.g., of processor set 110 or other processor sets), and/or one or more other computing devices, etc.). Although example computers, servers, devices, processors, nodes, processing circuitry and/or computing devices are provided, additional, fewer and/or other computers, servers, devices, processors, nodes, processing circuitry, and/or other computing devices may be used for the shift/add process and/or other processing. Various options are possible.

Referring to FIG. 7B, in one example, a shift/add process 720 (also referred to as process 720) obtains 722 (e.g., receives, retrieves, fetches, is provided, pulls, etc.) an instruction, such as shift-add instruction 700, and executes 730 the instruction. Execution includes, for instance, obtaining 732 one or more operands of the instruction. As examples, process 730 obtains one or more of: an operation code from opcode field 702, an indication of a result location (e.g., a vector register, etc.) from result field 704, inputs from input fields 706 and 708, a mask value from mask field 710 and a register extension bit from register extension bit field 712. The operands to be obtained depend, for instance, on which operands are specified using the instruction and/or are being used. As noted herein, some operands are optional and may not be used in various embodiments. Further, in one or more embodiments, additional, fewer and/or other operands may be used. Many variations are possible.

Based on obtaining the operands, in one example, process 720 determines 734 a variant of the shift-add instruction to be executed. For instance, a shift selection control (e.g., a value of the mask field (e.g., mask field 710)) is used to determine the variant. As an example, the mask includes two bits, and therefore, there are up to four variants, in this example. In one example, one mask bit controls whether to use the carry digit (which is, e.g., one bit, or more than one bit in other examples) on the input, and the other mask bit controls whether to shift (e.g., 30 bits or 60 bits, etc.). However, the mask may be of different sizes, and therefore, a different number of variants may be supported. Based on the value of the mask, and therefore, the variant, the shifting/adding to be performed is dynamically selected, as well as an indication of whether shifting is to be performed, as described herein.

In one example, based on determining the mask value, process 720 performs 740 the shift/add operation based on the variant, e.g., the mask value. Further details relating to performing the operation are described with reference to FIGS. 7C-7G. For example, FIG. 7C depicts one example of an overview of performing the shift/add operation; and FIGS. 7D-7G depict examples of performing the operation based on selected mask values. In one example, the perform operation is executed by one or more computing devices (e.g., one or more computers (e.g., computer(s) 101, other computer(s), etc.), one or more servers (e.g., server(s) 104, other server(s), etc.), one or more devices (e.g., end-user device(s) 103, other device(s), etc.), one or more processors, nodes and/or processing circuitry, etc. (e.g., of processor set 110 or other processor sets), and/or one or more other computing devices, etc.). Although example computers, servers, devices, processors, nodes, processing circuitry and/or computing devices are provided, additional, fewer and/or other computers, servers, devices, processors, nodes, processing circuitry, and/or other computing devices may be used for the shift/add process and/or other processing. Various options are possible.

In one example, referring to FIG. 7C, to perform the shift/add operation, a process 740 performs a shift 742 of an operand of the shift-add instruction being executed to align the operand with another operand of the instruction. Then, process 740 adds 744 the value of the shifted operand and the other operand to provide a shift-add result (may also be referred to herein as a sub-result), which is placed 746 in a designated location (e.g., indicated using result field 704).

The amount of the shift (and the operand being shifted) is based, for instance, on a shift selection control of the shift-add instruction being executed. In one example, the shift selection control is a mask value of the shift-add instruction. If, for instance, the mask value is 00, then, referring to FIG. 7D, a shift/add process 750 performs the following 752: for input register 0 (e.g., one input operand of instruction 700; e.g., the intermediate result provided from execution of multi-operation instruction 500 with mask=00 (referred to as result 00)), bits 29 down to 0 are disregarded; bits 30 through 127 are treated as being in bit positions 0 through 97 and are added to bits 0 through 127 of input register 1 (e.g., another input operand of instruction 700; e.g., the intermediate result provided from execution of multi-operation instruction 500 with mask=01 (referred to as result 01)), producing a 128 bit result and a carry value of 0 or 1. Process 750 places 754 the 128 bit result in a result register specified by, e.g., result field 704 of the shift-add instruction. The carry value (0 or 1) is placed in, e.g., a carry register, as one example.

As a further example, if, for instance, the mask value of the shift-add instruction is 01, then, referring to FIG. 7E, a shift/add process 760 performs the following 762: for input register 0 (e.g., one input operand of instruction 700; e.g., result of execution of shift-add instruction 700 with a mask value of 11 (referred to as nr2)), bits 59 down to 0 are disregarded; bits 60 through 127 are treated as being in bit positions 0 through 67 and are added to bits 0 through 127 of input register 1 (e.g., another input operand of instruction 700; e.g., the intermediate result provided from execution of multi-operation instruction 500 with mask=11 (referred to as result 11)), producing a 128 bit result and a carry value of 0 or 1. Process 760 places 764 the 128 bit result in a result register specified by, e.g., result field 704 of the shift-add instruction. The carry value (0 or 1) is placed in the carry register, as one example.

As a further example, if, for instance, the mask value of the shift-add instruction is 10, then, referring to FIG. 7F, a shift/add process 770 performs the following 772: for input register 0 (e.g., one input operand of instruction 700), bits 29 down to 0 are disregarded; bits 30 through 127 are treated as being in bit positions 0 through 97. The value of the carry register is treated as being bit 98 in the 0th input, and all these bits 0 through 98 are added to bits 0 through 127 of input register 1 (e.g., another operand of instruction 700), producing a 128 bit result and a carry value of 0 or 1. Process 770 places 774 the 128 bit result in a result register specified by, e.g., result field 704 of the shift-add instruction. The carry value (0 or 1) is placed in the carry register, as one example. In one embodiment, this variant is not used in determining the product described in the example herein; however, it may be used for other examples.

As a further example, if, for instance, the mask value of the shift-add instruction is 11, then, referring to FIG. 7G, a shift/add process 780 performs the following 782: for input register 0 (one input operand of instruction 700; e.g., result of first execution of shift-add instruction 700 with mask=00 (referred to an nr1)), bits 59 down to 0 are disregarded 782; bits 60 through 127 are treated as being in bit positions 0 through 67. The value of the carry register is treated as being bit 68 in the 0th input, and all these bits 0 through 98 are added to bits 0 through 127 of input register 1 (e.g., another input operand of instruction 700; e.g., the intermediate result provided from execution of multi-operation instruction 500 with mask=10 (referred to as result 10)), producing a 128 bit result and a carry value of 0 or 1. Process 780 places 784 the 128 bit result in a result register specified by, e.g., result field 704 of the shift-add instruction. The carry value (0 or 1) is placed in the carry register, as one example.

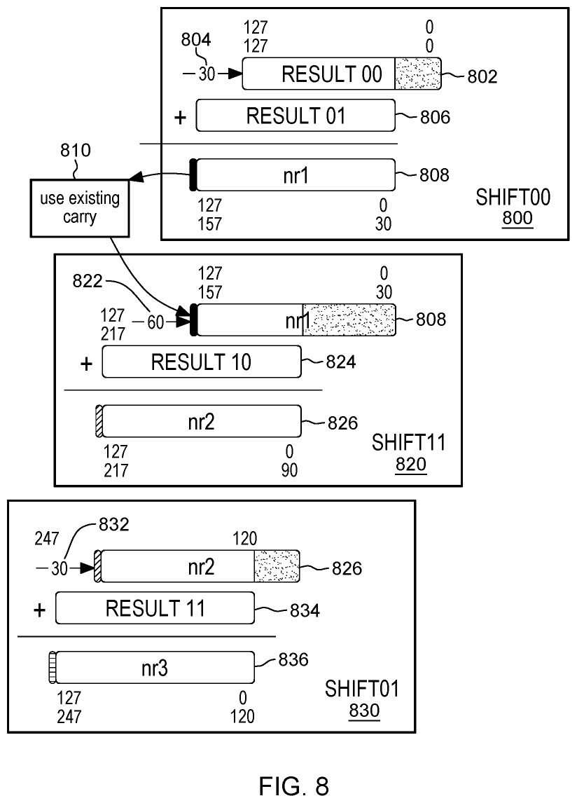

For instance, as depicted in FIG. 8, a shift-add instruction with a mask value of 00 (800) is executed, and based thereon, a result of the multi-operation instruction with a mask value of 00 (e.g., result 00) (802) is shifted 804 a selected amount (e.g., 30 bits) to provide alignment with a result of the multi-operation instruction with a mask value of 01 (e.g., result 01) (806). The values of result 00 shifted and result 01 are added providing a shift-add result (nr1) 808, which may or may not have a carry 810.

In one or more aspects, further shifts/adds are performed. For instance, as shown in FIG. 8, a shift-add instruction with a mask value set to 11 (820) is executed. Thus, in one example, the result from the first shift/add (e.g., nr1 808) is shifted 822 a selected amount (e.g., 60 bits) and added to a result of the multi-operation instruction with a mask value of 10 (e.g., result 10) (824) providing a shift-add result (nr2) 826.

Additionally, in one example, a shift-add instruction (e.g., shift-add instruction 700) is executed again, but this time the mask value is set to 01 (830). Thus, in one example, the result from the second shift/add (e.g., nr2 826) is shifted 832 a selected amount (e.g., 30 bits) and added to a result of the multi-operation instruction with a mask value of 11 (e.g., result 11) (834) providing a shift-add result (nr3) 836. This shift-add result is part of the final product of multiplying the multiple (e.g., two) values.

In one example, to determine the final product, appended, e.g., left to right, are shifted bits 0-30 of result 802, shifted bits 0-60 of result 808, shifted bits 0-30 of result 826, bits 0-127 of result 836 and the carry bit.

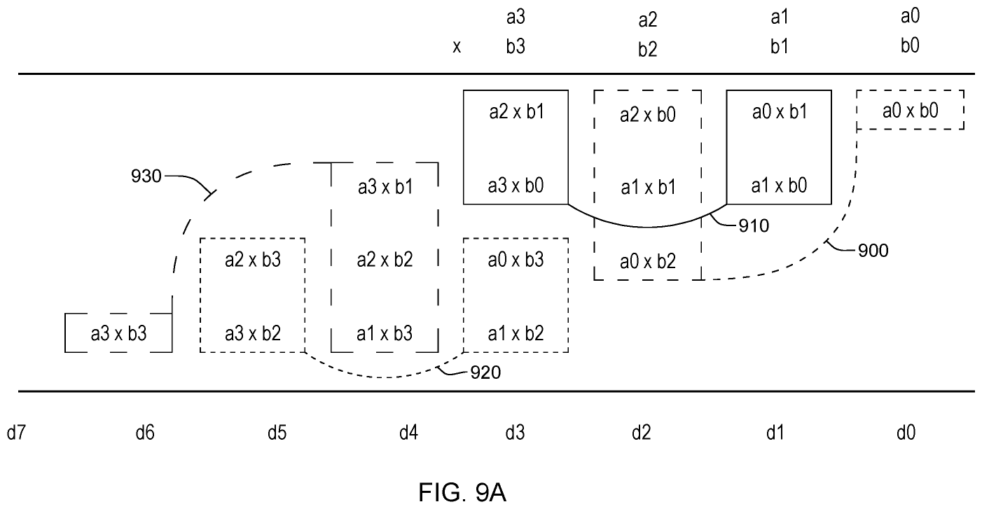

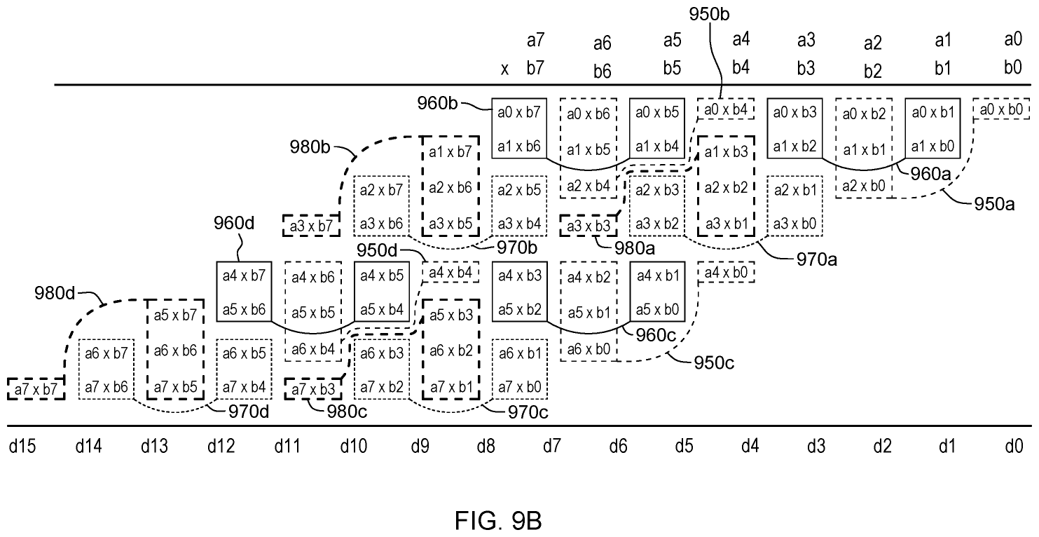

As indicated above, there are various variants for the multi-operation and shift-add instructions. These variants are based on groups of digits to be multiplied. The groups are generated, in one or more examples, to optimize the configuration of hardware used to implement the multi-operation processing. For example, a reduced set of multiplexors and multipliers are configured to perform the processing. Further, the configuration, in one example, is to reduce redundancy (e.g., reduce duplicative calculations). Example groups of digits are shown in FIGS. 9A-9B.

For instance, FIG. 9A depicts four (4) groups 900-930 for a multiplication of four (4) digits of one value by four (4) digits of another value to produce a product. In one example, each digit is, e.g., 32 bits wide; however, this includes space for a carry digit (e.g., the digit is 30 bits and 2 bits are used for two carry bits). In other examples, each digit may have a different number of bits.

Further sets of groups based on a multiplication of a value of eight (8) digits by another value of eight (8) digits are depicted in FIG. 9B. As shown in FIG. 9B, there are four sets of groups: group 1 (950a-980a); group 2 (950b-980b); group 3 (950c-980c); and group 4 (950d-980d). Each group is processed as described herein in order to perform a multiplication of two values (each having multiple digits, wherein each digit is a selected number of bits (e.g., 32 bits including space for, e.g., two carry bits, or another number of bits and/or carry bits).

Although example sets of groups are shown, other examples are possible based on the number of digits being multiplied. Various examples are possible. Further, if one value has less digits, then 0s are used in its place, in one example. Additionally, further optimizations may be performed when 0s are used. Many variations are possible.

In accordance with one or more aspects, digits of multiple values (e.g., 2 values) to be multiplied are grouped in a manner in which implementation of the hardware to perform the multiplication is optimized. For instance, a set of multiplexors and multipliers is configured to perform the implementation, and the configuration minimizes the number of multiplexors and multipliers used. The multiplexors and multipliers use select inputs based on a selection control. As an example, the selection control is included in the instruction used to perform the multiplication. For example, the selection control is a mask value of the instruction.

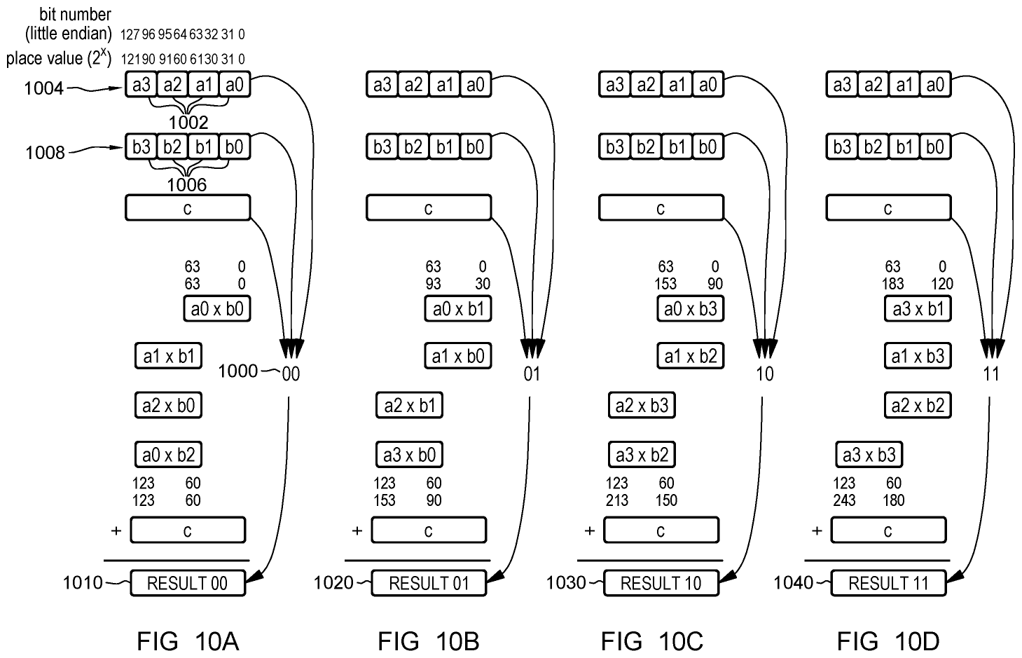

For example, referring to FIG. 10A, a multi-operation instruction 1000 with a mask value of 00 is used to multiply digits 1002 of one value 1004 with digits 1006 of another value 1008 to obtain a first intermediate result (e.g., result 00) 1010. As an example, digit a0 is multiplied by digit b0 to provide a result (e.g., result 1); digit a1 is multiplied by digit b1 and shifted a selected number of bits (e.g., 60 bits) providing a result (e.g., shifted result 1); digit a2 is multiplied by digit b0 and shifted a selected number of bits (e.g., 60 bits) providing a result (e.g., shifted result 2); and digit a0 is multiplied by digit b2 providing a result (e.g., result 4) and shifted a selected number of bits (e.g., 60 bits). Result 1, shifted result 1, shifted result 2 and result 4 shifted are added together, along with an accumulator (c), if any, to provide result 1010 (result 00), which is used, along with other intermediate results (e.g., results 1020-1040), to produce a product of one value 1004 multiplied with the other value 1008.

Referring to FIGS. 10B-10D, each of the other results (e.g., 1020-1040) is obtained by re-executing the multi-operation instruction 1000 multiple times with different mask values (or executing different multi-operation instructions with different opcodes (selection controls), one for each mask, as an example). For example, multi-operation instruction 1000 with a mask 01 is used to multiply digits of a second group of digits (e.g., 910 FIG. 9A) to provide another set of results/shifted results, which are added together, along with an accumulator, if any, to provide result 01 (1020). Further, multi-operation instruction 1000 with a mask 10 is used to multiply digits of a third group of digits (e.g., 920) to provide another set of results/shifted results, which are added together, along with an accumulator, if any, to provide result 10 (1030); and multi-operation instruction 1000 with a mask 11 is used to multiply digits of a fourth group of digits (e.g., 930) to provide another set of results/shifted results, which are added together, along with an accumulator, if any, to provide result 11 (1040).

The results (1010-1040) are then used to compute a product of the one value and the other value. For instance, selected results are input to various instances of shift-add instructions (e.g., a shift-add instruction with a shift select control, such as a mask value, or multiple different shift-add instructions) to provide shift-add results. The shift-add results are used to determine the product of the one value (e.g., value 1004) multiplied by another value (e.g., value 1008), as described herein.

By grouping the digits into groups, providing predefined groups of digits to be processed, an optimized set of hardware is able to be configured to implement the processing (e.g., multiplying multiple (e.g., two) values to obtain a product, in which each value includes multiple digits of a plurality of bits (e.g., 32, 64 or other bits). This improves processing within a computer by reducing the cost, increasing speed of processing and reducing the amount of hardware to be used. It enables a fixed set of hardware to be used that provides parallelism and low latency. Carry bits are maintained, in one example, with each product so that a carry register is not used during the multiplication, increasing processing speed and reducing latency. Redundant computations are avoided.

By optimizing the processing (e.g., multiplication), the results of the processing may be used to improve processing of other computer operations, such as secure communications, cryptographic operations (e.g., digital signatures and/or key exchanges that use multiplication), blockchains and/or other operations that use such processing (e.g., multiplication computations). By increasing the speed and decreasing the cost of implementing selected computations, such as the multiplications, the secure communications, cryptographic operations, blockchains and/or other operations within the computer are improved.

Other variations and embodiments are possible.

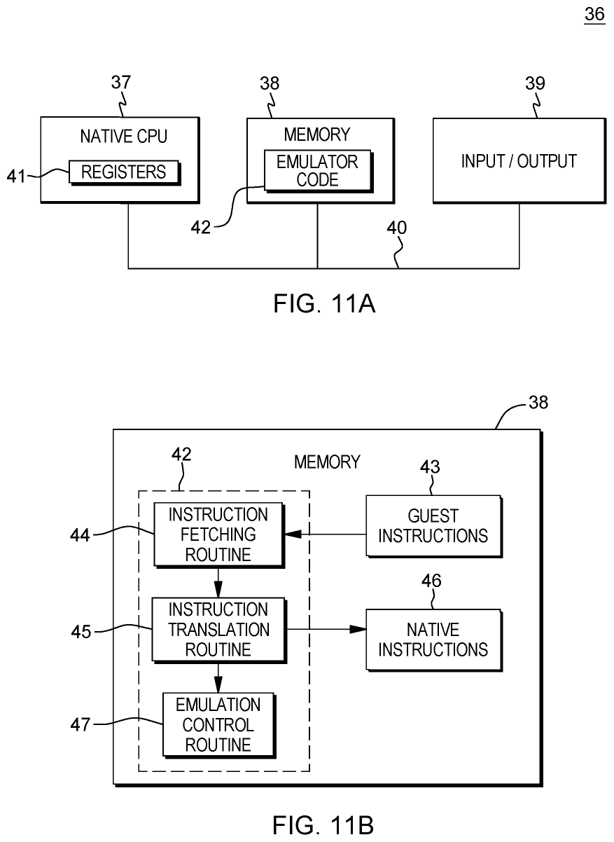

Further, although one or more examples of a computing environment to incorporate and use one or more aspects of the present disclosure are described herein, FIGS. 11A-11B depict another embodiment of a computing environment to incorporate and use one or more aspects of the present disclosure.

Referring, initially, to FIG. 11A, in this example, a computing environment 36 includes, for instance, a native central processing unit (CPU) 37 based on one architecture having one instruction set architecture, a memory 38, and one or more input/output devices and/or interfaces 39 coupled to one another via, for example, one or more buses 40 and/or other connections.

Native central processing unit 37 includes one or more native registers 41, such as one or more general purpose registers and/or one or more special purpose registers used during processing within the environment. These registers include information that represents the state of the environment at any particular point in time.

Moreover, native central processing unit 37 executes instructions and code that are stored in memory 38. In one particular example, the central processing unit executes emulator code 42 stored in memory 38. This code enables the computing environment configured in one architecture to emulate another architecture (different from the one architecture) and to execute software and instructions developed based on the other architecture.

Further details relating to emulator code 42 are described with reference to FIG. 11B. Guest instructions 43 stored in memory 38 comprise software instructions (e.g., correlating to machine instructions) that were developed to be executed in an architecture other than that of native CPU 37. For example, guest instructions 43 may have been designed to execute on a processor based on the other instruction set architecture, but instead, are being emulated on native CPU 37, which may be, for example, the one instruction set architecture. In one example, emulator code 42 includes an instruction fetching routine 44 to obtain one or more guest instructions 43 from memory 38, and to optionally provide local buffering for the instructions obtained. It also includes an instruction translation routine 45 to determine the type of guest instruction that has been obtained and to translate the guest instruction into one or more corresponding native instructions 46. This translation includes, for instance, identifying the function to be performed by the guest instruction and choosing the native instruction(s) to perform that function.

Further, emulator code 42 includes an emulation control routine 47 to cause the native instructions to be executed. Emulation control routine 47 may cause native CPU 37 to execute a routine of native instructions that emulate one or more previously obtained guest instructions and, at the conclusion of such execution, return control to the instruction fetch routine to emulate the obtaining of the next guest instruction or a group of guest instructions. Execution of the native instructions 46 may include loading data into a register from memory 38; storing data back to memory from a register; or performing some type of arithmetic or logic operation, as determined by the translation routine.

Each routine is, for instance, implemented in software, which is stored in memory and executed by native central processing unit 37. In other examples, one or more of the routines or operations are implemented in firmware, hardware, software or some combination thereof. The registers of the emulated processor may be emulated using registers 41 of the native CPU or by using locations in memory 38. In embodiments, guest instructions 43, native instructions 46 and emulator code 42 may reside in the same memory or may be disbursed among different memory devices.

An example instruction that may be emulated is the multi-operation instruction and/or the shift-add instruction described herein, in accordance with one or more aspects of the present disclosure.

The computing environments described herein are only examples of computing environments that can be used. One or more aspects of the present disclosure may be used with many types of environments. The computing environments provided herein are only examples. Each computing environment is capable of being configured to include one or more aspects of the present disclosure. For instance, each may be configured to implement multi-digit processing and/or to perform one or more other aspects of the present disclosure.

One or more aspects of the present disclosure are tied to computer technology and facilitate processing within a computer, improving performance thereof. For instance, processing speed is increased, and storage requirements and costs are reduced. One or more aspects provide parallel processing and low latency. Processing within a processor, computer system and/or computing environment is improved.

Other aspects, variations and/or embodiments are possible.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

Yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, other instruction formats, operands and/or registers may be used. For example, instead of one or more of the vector registers used by the instructions, one or more of the registers may be general purpose registers and/or one or more of the locations used by the instructions may be memory locations. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product for facilitating processing within a computing environment, the computer program product comprising:
one or more computer readable storage media and program instructions collectively stored on the one or more computer readable storage media readable by at least one processing circuit to:
execute a multi-operation computer instruction to obtain an intermediate result, wherein execution of the multi-operation computer instruction includes:
selecting, by at least one computing device of the computing environment, digits of a plurality of digits to be multiplied, wherein a location defined to hold a digit of the plurality of digits is greater in size than a size of the digit and is further defined to hold a carry digit, the plurality of digits being of multiple values to be multiplied to obtain a product, and wherein the selecting selects the digits from a predefined group of digits of a plurality of predefined groups of digits chosen based on a selection control of the multi-operation computer instruction;
multiplying the digits selected to be multiplied to obtain a plurality of results;
shifting at least one result a preselected amount to obtain at least one shifted result, based on determining based on the predefined group of digits that a shift is to be performed; and
adding, at least, one or more results of the plurality of results and the at least one shifted result, based on determining that the shift is to be performed, to obtain an intermediate result of a plurality of intermediate results;
repeat, multiple times, execution of the multi-operation computer instruction for multiple other predefined groups of digits of the plurality of predefined groups of digits to obtain the plurality of intermediate results; and
use the plurality of intermediate results to obtain the product.

2. The computer program product of claim 1, wherein the plurality of predefined groups is determined to reduce use of computer hardware in performing multiplication of the multiple values.

3. The computer program product of claim 1, wherein the execution of the multi-operation computer instruction further comprises obtaining a mask value of the multi-operation computer instruction, the mask value corresponding to a selected predefined group of digits of the plurality of predefined groups of digits and being the selection control.

4. The computer program product of claim 1, wherein the execution of the multi-operation computer instruction further comprises placing the intermediate result in a target location, the target location specified using the multi-operation computer instruction.

5. The computer program product of claim 1, wherein the program instructions readable by the at least one processing circuit to use the plurality of intermediate results to obtain the product are further readable by the at least one processing circuit to perform one or more selected shift operations on one or more selected results to obtain the product, the one or more selected results including at least one intermediate result of the plurality of intermediate results and at least one sub-result obtained from performing, at least, a selected shift operation of the one or more selected shift operations.

6. The computer program product of claim 5, wherein the program instructions readable by the at least one processing circuit to perform the one or more selected shift operations are further readable by the at least one processing circuit to execute one or more shift-add computer instructions to perform the one or more selected shift operations.

7. The computer program product of claim 6, wherein the one or more shift-add computer instructions comprises one shift-add computer instruction executed multiple times, wherein an execution of the one shift-add computer instruction is controlled by a shift selection control, the shift selection control controlling which at least one selected result of the one or more selected results is to be shifted and an amount to be shifted.

8. The computer program product of claim 7, wherein the shift selection control further controls whether to use an input carry digit on an input to the one shift-add computer instruction.

9. The computer program product of claim 7, wherein the shift selection control is a mask value of the one shift-add computer instruction.

10. The computer program product of claim 7, wherein the one shift-add computer instruction further performs an adding operation of multiple selected results to obtain a shift-add result, the shift-add result to be used in determining the product.

11. The computer program product of claim 1, wherein the selecting the digits comprises using one or more multiplexors of the at least one computing device to select the digits to be multiplied.

12. The computer program product of claim 11, wherein the one or more multiplexors are configured for the plurality of predefined groups to facilitate processing within the computing environment.

13. A computer system for facilitating processing within a computing environment, the computer system comprising:
a memory; and
one or more computing devices in communication with the memory, wherein the computer system is configured to perform a method, said method comprising:
executing a multi-operation computer instruction to obtain an intermediate result, wherein the executing the multi-operation computer instruction includes:
selecting digits of a plurality of digits to be multiplied, wherein a location defined to hold a digit of the plurality of digits is greater in size than a size of the digit and is further defined to hold a carry digit, the plurality of digits being of multiple values to be multiplied to obtain a product, and wherein the selecting selects the digits from a predefined group of digits of a plurality of predefined groups of digits chosen based on a selection control of the multi-operation computer instruction;
multiplying the digits selected to be multiplied to obtain a plurality of results;
shifting at least one result a preselected amount to obtain at least one shifted result, based on determining based on the predefined group of digits that a shift is to be performed; and
adding, at least, one or more results of the plurality of results and the at least one shifted result, based on determining that the shift is to be performed, to obtain an intermediate result of a plurality of intermediate results;
repeating, multiple times, execution of the multi-operation computer instruction for multiple other predefined groups of digits of the plurality of predefined groups of digits to obtain the plurality of intermediate results; and
using the plurality of intermediate results to obtain the product.

14. The computer system of claim 13, wherein the executing the multi-operation computer instruction further comprises obtaining a mask value of the multi-operation computer instruction, the mask value corresponding to a selected predefined group of digits of the plurality of predefined groups of digits and being the selection control.

15. The computer system of claim 13, wherein the using the plurality of intermediate results to obtain the product includes performing one or more selected shift operations on one or more selected results to obtain the product, the one or more selected results including at least one intermediate result of the plurality of intermediate results and at least one sub-result obtained from performing, at least, a selected shift operation of the one or more selected shift operations.

16. The computer system of claim 15, wherein the performing the one or more selected shift operations comprises executing one or more shift-add computer instructions to perform the one or more selected shift operations, and wherein the one or more shift-add computer instructions comprises one shift-add computer instruction executed multiple times, wherein an execution of the one shift-add computer instruction is controlled by a shift selection control, the shift selection control controlling which at least one selected result of the one or more selected results is to be shifted and an amount to be shifted.

17. A computer-implemented method of facilitating processing within a computing environment, the computer-implemented method comprising:
executing a multi-operation computer instruction to obtain an intermediate result, wherein the executing the multi-operation computer instruction includes:
selecting, by at least one computing device of the computing environment, digits of a plurality of digits to be multiplied, wherein a location defined to hold a digit of the plurality of digits is greater in size than a size of the digit and is further defined to hold a carry digit, the plurality of digits being of multiple values to be multiplied to obtain a product, and wherein the selecting selects the digits from a predefined group of digits of a plurality of predefined groups of digits chosen based on a selection control of the multi-operation computer instruction;
multiplying the digits selected to be multiplied to obtain a plurality of results;
shifting at least one result a preselected amount to obtain at least one shifted result, based on determining based on the predefined group of digits that a shift is to be performed; and
adding, at least, one or more results of the plurality of results and the at least one shifted result, based on determining that the shift is to be performed, to obtain an intermediate result of a plurality of intermediate results;
repeating, multiple times, execution of the multi-operation computer instruction for multiple other predefined groups of digits of the plurality of predefined groups of digits to obtain the plurality of intermediate results; and
using the plurality of intermediate results to obtain the product.

18. The computer-implemented method of claim 17, wherein the executing the multi-operation computer instruction further comprises obtaining a mask value of the multi-operation computer instruction, the mask value corresponding to a selected predefined group of digits of the plurality of predefined groups of digits and being the selection control.

19. The computer-implemented method of claim 17, wherein the using the plurality of intermediate results to obtain the product includes performing one or more selected shift operations on one or more selected results to obtain the product, the one or more selected results including at least one intermediate result of the plurality of intermediate results and at least one sub-result obtained from performing, at least, a selected shift operation of the one or more selected shift operations.

20. The computer-implemented method of claim 19, wherein the performing the one or more selected shift operations comprises executing one or more shift-add computer instructions to perform the one or more selected shift operations, and wherein the one or more shift-add computer instructions comprises one shift-add computer instruction executed multiple times, wherein an execution of the one shift-add computer instruction is controlled by a shift selection control, the shift selection control controlling which at least one selected result of the one or more selected results is to be shifted and an amount to be shifted.
